(19) United States
(12) Patent Application Publication
(10) Pub. No.: US 2023/0382676 A1
(43) Pub. Date: Nov. 30, 2023

(54) DOCUMENT CONVEYING DEVICE, IMAGE READING APPARATUS, AND MULTIFUNCTION PERIPHERAL CAPABLE OF COVERING TRAY

(71) Applicant: KYOCERA Document Solutions Inc., Osaka (JP)

(72) Inventor: Ren Isoda, Osaka (JP)

(21) Appl. No.: 18/322,479

(22) Filed: May 23, 2023

(30) Foreign Application Priority Data
May 25, 2022 (JP) 2022-085264

(51) Int. Cl. B65H 31/22

(52) U.S. Cl. CPC B65H 31/22; B65H 2801/06

(57) ABSTRACT

A document sheet conveying device includes a slide cover. The slide cover is provided slidably between an open position for exposing the supply tray and the discharge tray and a closing position for covering the supply tray and the discharge tray. In addition, the slide cover includes a cover main body and a side cover. The cover main body is formed by connecting at least a top plate covering the supply tray and a front plate covering a front side of the discharge space when the slide cover is disposed at the closing position. The side cover is rotatably connected to a top surface side of the cover main body, covers one of right and left sides of the discharge space when the slide cover is disposed at the closing position.

### INCORPORATION BY REFERENCE

This application is based upon and claims the benefit of priority from the corresponding Japanese Patent Application No. 2022-085264 filed on May 25, 2022, the entire contents of which are incorporated herein by reference.

### BACKGROUND

The present disclosure relates to a document sheet conveying device, an image reading apparatus, and a multifunction peripheral which convey a document sheet.

For example, in a conventional image forming apparatus, an image forming portion is provided inside an apparatus main body, and an automatic document sheet conveying device and a scanner are provided above the apparatus main body. Between the image forming portion and the scanner, an in-body sheet discharge portion which opens the front and left sides of the apparatus main body is provided. A sheet discharge front cover is rotatably provided at a lower edge of the front opening, and a sheet discharge left cover is rotatably provided at a lower edge of the left opening. These covers are formed in a flat plate shape so as to fit the openings, and by closing these covers, not only the driving noise leaking from the in-body sheet discharge portion is reduced, but also the taking away of printed materials is suppressed.

### SUMMARY

A document sheet conveying device according to the present disclosure includes a conveyance housing, a supply tray, a discharge tray, and a slide cover. The conveyance housing includes a document sheet conveying path for conveying a document sheet. The supply tray extends from the conveyance housing in one of left and right directions, and the document sheet is set thereon. The discharge tray is provided below the supply tray with a discharge space interposed therebetween, and the document sheet fed from the supply tray and conveyed along the document sheet conveying path is loaded thereon. The slide cover is formed in a box-like shape capable of enclosing the supply tray and the discharge tray and provided slidably in the left and right directions between an open position for exposing the supply tray and the discharge tray and a closing position for covering the supply tray and the discharge tray. In addition, the slide cover includes a cover main body and a side cover. The cover main body is formed by connecting at least a top plate covering the supply tray and a front plate covering a front side of the discharge space when the slide cover is disposed at the closing position. The side cover is rotatably connected to a top surface side of the cover main body, covers one of right and left sides of the discharge space when the slide cover is disposed at the closing position, and is pushed up by interfering with the supply tray in a process of being slid from the closing position to the open position.

An image reading apparatus according to the present disclosure includes the document sheet conveying device and a reading portion. The reading portion reads an image of the document sheet conveyed along the document sheet conveying path.

A multifunction peripheral according to the present disclosure includes the image reading apparatus and an image forming apparatus. The image forming apparatus forms an image on a medium.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram (front view) showing an internal structure of a multifunction peripheral according to an embodiment of the present disclosure.

FIG. 2 is a perspective view (open position) showing a document sheet conveying device according to an embodiment of the present disclosure.

FIG. 3 is a perspective view (unlocked state) showing the document sheet conveying device according to an embodiment of the present disclosure.

FIG. 4 is a perspective view (closing position, locked state) showing the document sheet conveying device according to an embodiment of the present disclosure.

FIG. 5 is a schematic diagram (front view) showing a cover mechanism portion of the document sheet conveying device according to an embodiment of the present disclosure.

FIG. 6 is a schematic diagram (front view) showing a cover mechanism portion of a document sheet conveying device according to a modification of an embodiment of the present disclosure.

### DETAILED DESCRIPTION

Hereinafter, an embodiment of the present disclosure will be described with reference to the accompanying drawings. It is noted that Fr, Rr, L, R, U, and D shown in the drawings indicate front, rear, left, right, up, and down. Although terms indicating directions and positions are used herein, such terms are used for convenience of description and do not limit the technical scope of the present disclosure.

[Multifunction Peripheral]

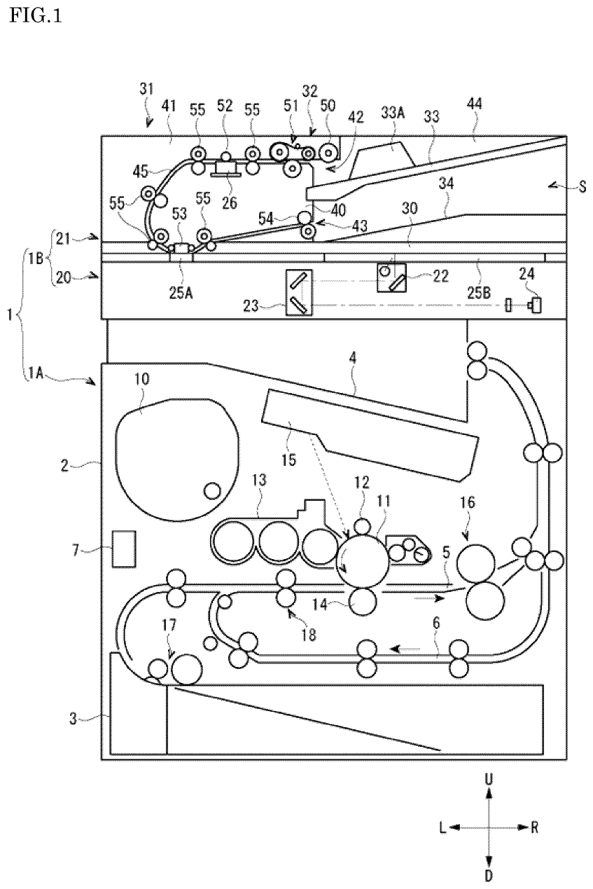

A multifunction peripheral 1 will be described with reference to FIG. 1. FIG. 1 is a schematic diagram (front view) showing an internal structure of the multifunction peripheral 1.

The multifunction peripheral 1 includes an image forming apparatus 1A that forms an image on a sheet (medium (not shown)) by an electrophotographic method, and an image reading apparatus 1B that optically reads an image of a document sheet.

[Image Forming Apparatus]

As shown in FIG. 1, the image forming apparatus 1A includes an apparatus main body 2, which constitutes a substantially rectangular parallelepiped exterior. A sheet feed cassette 3 that houses sheets is detachably provided in a lower portion of the apparatus main body 2, and a sheet discharge tray 4 is provided on an upper surface of the apparatus main body 2. In addition, the image forming apparatus 1A includes a toner container 10, a photoconductor drum 11, a charging device 12, a developing device 13, a transfer roller 14, a laser scanning unit 15, and a fixing device 16.

The toner container 10 is disposed in an upper left portion of the apparatus main body 2 and stores, for example, black toner (developer). The photoconductor drum 11 is provided on a midstream part of a first conveying path 5 extending from the sheet feed cassette 3 to the sheet discharge tray 4. The charging device 12, the developing device 13, and the transfer roller 14 are disposed around the photoconductor drum 11 in image forming processing order. The transfer roller 14 contacts the photoconductor drum 11 from below to form a transfer nip. The laser scanning unit 15 is provided above the photoconductor drum 11. The fixing device 16 is provided on a downstream part of the first conveying path 5.

A sheet feed portion 17 is provided at an upstream end of the first conveying path 5, and a registration roller pair 18 is provided on a midstream part of the first conveying path 5. Inside the apparatus main body 2, there is provided a second conveying path 6 which branches off from a downstream part of the first conveying path 5 and joins an upstream part of the first conveying path 5. It is noted that the first conveying path 5 and the second conveying path 6 are provided with a plurality of conveying roller pairs for conveying sheets.

The multifunction peripheral 1 is provided with a control device 7 for controlling various control target devices as appropriate. The control device 7 includes a processor or the like that executes various kinds of arithmetic processing in accordance with programs and parameters stored in a memory. In addition, the multifunction peripheral 1 is provided with a display input portion (not shown) such as a touch panel or buttons for inputting various instructions from the user (operator). The display input portion is electrically connected to the control device 7, and transmits an input signal to the control device 7 and receives an electric signal (for example, display information to the touch panel) from the control device 7.

[Image Forming Processing]

An operation of the image forming apparatus 1A will be described. The control device 7 executes image forming processing as follows based on, for example, image data input from an external terminal.

The charging device 12 charges the surface of the photoconductor drum 11, and the laser scanning unit 15 emits scanning light based on the image data to form an electrostatic latent image on the surface of the photoconductor drum 11. The developing device 13 develops a toner image on the surface of the photoconductor drum 11 using toner supplied from the toner container 10. The sheet feed portion 17 feeds sheets from the sheet feed cassette 3 one by one to the first conveying path 5. The sheet is conveyed along the first conveying path 5, is skew-corrected by the registration roller pair 18, and enters the transfer nip. The transfer roller 14 transfers the toner image on the photoconductor drum 11 onto the sheet passing the transfer nip, and the fixing device 16 thermally fixes the toner image on the sheet. In the case of single-sided printing, the sheet is discharged to the sheet discharge tray 4.

In the case of double-sided printing, the sheet is switched back at a downstream end of the first conveying path 5, conveyed along the second conveying path 6, and returned to the first conveying path 5. Thereafter, an image is formed on the back side of the sheet through the same processing as above, and the double-sided printed sheet is discharged to the sheet discharge tray 4.

[Image Reading Apparatus]

As shown in FIG. 1, the image reading apparatus 1B includes a reading device 20 and a document sheet conveying device 21. The reading device 20 is attached to the upper surface of the apparatus main body 2, and is disposed above the sheet discharge tray 4 with a sheet discharge space therebetween. The document sheet conveying device 21 is attached to the upper surface of the reading device 20.

<Reading Device>

The reading device 20 includes a laser scanning unit 22, a reflection unit 23, and a reading portion 24. The laser scanning unit 22 applies light onto a document sheet placed on a contact glass 25A or a platen glass 25B. The reflection unit 23 reflects the light reflected from the document sheet toward the reading portion 24. When a document sheet on the platen glass 25B is read, the laser scanning unit 22 and the reflection unit 23 move so that the optical path length from the document sheet to the reading portion 24 is constant. The reading portion 24 is an image sensor that photoelectrically converts the input light. It is noted that the reading device 20 includes a second reading portion 26 (image sensor), and the second reading portion 26 is provided inside a conveyance housing 31 of the document sheet conveying device 21 to be described later.

<Document Sheet Conveying Device>

The document sheet conveying device 21 includes a document sheet holding portion 30, a conveyance housing 31, a conveying mechanism portion 32, a supply tray 33, and a discharge tray 34. It is noted that, in the description of the image reading apparatus 1B, the direction in which the document sheet is conveyed will be referred to as a “conveying direction”, and the terms “upstream” and “downstream” and similar terms refer to the “upstream” and “downstream” in the conveying direction and similar concepts.

The document sheet holding portion 30 is rotatably (openably and closably) attached to a rear portion of the upper surface of the reading device 20 via a hinge (not shown). The conveyance housing 31 is formed in a substantially rectangular parallelepiped shape, and is disposed mainly on a substantially left half of the document sheet holding portion 30. The conveying mechanism portion 32 is built in the conveyance housing 31. The supply tray 33 extends obliquely upward from (the upper right portion of) the conveyance housing 31 toward the right (in one of the left and right directions). The supply tray 33 is provided with a pair of cursors 33A, which are movable in the front-rear direction, and which are brought into contact with both the front and rear ends of the document sheet to align the document sheet. The discharge tray 34 is formed on the upper surface of the document sheet holding portion 30 and is provided below the supply tray 33 with a discharge space S interposed therebetween. A document sheet whose image is to be read is set on the supply tray 33, and a document sheet whose image has been read is discharged (loaded) on the discharge tray 34.

(Conveyance Housing)

The conveyance housing 31 includes a support portion 40 and a housing cover 41. A supply port 42 and a discharge port 43 are formed in the right side surface of the conveyance housing 31 so as to correspond to the supply tray 33 and the discharge tray 34.

A document sheet conveying path 45 for conveying a document sheet is formed in the support portion 40 (inside the conveyance housing 31). The document sheet conveying path 45 is formed in a substantially U-shape connecting the supply port 42 and the discharge port 43. The housing cover 41 is disposed so as to cover the support portion 40, and a part of the housing cover 41 is rotatably supported by the support portion 40. By flipping up a part of the housing cover 41, the document sheet conveying path 45 is opened to allow jammed document sheets to be removed (not shown).

In addition, an extension portion 44 supporting the rear ends of the supply tray 33 and the discharge tray 34 is provided on a rear portion of a substantially right half of the document sheet holding portion 30. The extension portion 44 is formed integrally with the conveyance housing 31 (housing cover 41), and closes the back side of the discharge space S. That is, the front side and the right side of the discharge space S are open, and the document sheet discharged to the discharge tray 34 is taken out to the front or right. It is noted that the document sheet holding portion 30 and the extension portion 44 may be regarded as a part of the conveyance housing 31. In addition, since the discharge tray 34 is formed on the upper surface of the document sheet holding portion 30, the discharge tray 34 may be regarded as a part of the document sheet holding portion 30 or a part of the conveyance housing 31. In other words, the conveyance housing 31 may be regarded as including the document sheet holding portion 30, the discharge tray 34, and the extension portion 44.

(Conveying Mechanism Portion)

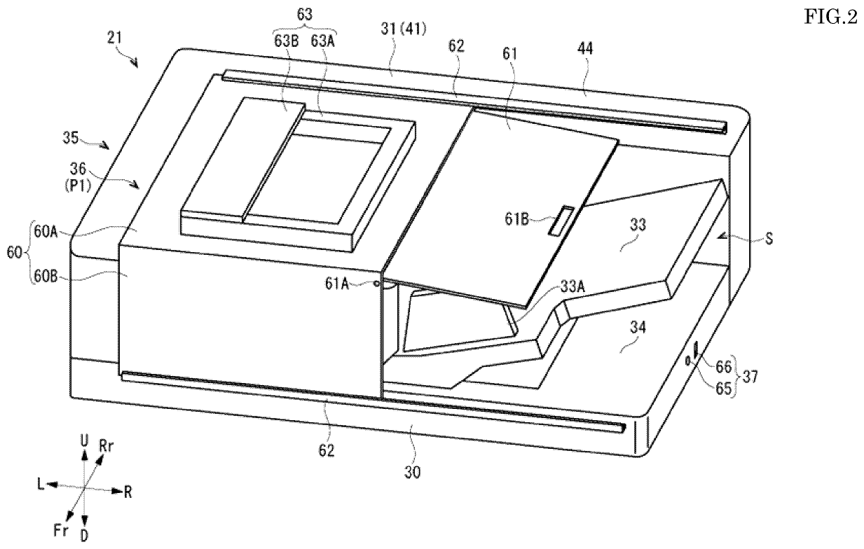

The conveying mechanism portion 32 is supported by the conveyance housing 31 (support portion 40). The conveying mechanism portion 32 includes a pickup roller 50, a separation unit 51, a correction roller 52, a correction portion 53, and a discharge roller pair 54. It is noted that a plurality of document sheet conveying roller pairs 55 are provided at appropriate positions on the document sheet conveying path 45 (see FIG. 2). The discharge roller pair 54 and the document sheet conveying roller pairs 55 convey the document sheet by rotating while nipping the document sheet.

The pickup roller 50 is provided at an upstream end of the document sheet conveying path 45 (near the supply port 42). The separation unit 51 is provided near the pickup roller 50 on the downstream side thereof. The separation unit 51 includes a belt hung on two pulleys and a separation roller in contact with the belt. The correction roller 52 has a reflective surface that performs shading correction, and is disposed on the upper side of the document sheet conveying path 45. The above-described second reading portion 26 is disposed so as to face the correction roller 52 from below. The correction portion 53 is a reflector that performs shading correction, and is disposed on the contact glass 25A. The discharge roller pair 54 is provided at a downstream end of the document sheet conveying path 45 (near the discharge port 43).

[Image Reading Processing]

An operation of the image reading apparatus 1B will be described. It is noted that, although the document sheets to be loaded on the supply tray 33 are sheet-shaped, the document sheets to be loaded on the platen glass 25B are not limited to sheet-shaped ones, and may be thick documents such as a booklet.

<Reading Document Sheet on Platen Glass>

The user opens the document sheet holding portion 30 to set a document sheet on the platen glass 25B, closes the document sheet holding portion 30, and operates the display input portion such as buttons to provide an instruction (input) for image reading. The control device 7 receives the input and executes image reading processing by controlling various control targets as follows. The laser scanning unit 22 applies light to the document sheet on the platen glass 25B while moving in the right direction. The light reflected by the document sheet is input to the reading portion 24 and converted into an electric signal, whereby the image of the document sheet is read as image data.

<Reading Document Sheet Set on Supply Tray>

The user sets a document sheet on the supply tray 33 with the document sheet holding portion 30 closed, and operates the display input portion to provide an instruction (input) for image reading. The control device 7 receives the input and executes image reading processing by controlling various control targets as follows.

The pickup roller 50 feeds the document sheet loaded on the supply tray 33 to the document sheet conveying path 45. Even when two or more document sheets are piled up, the document sheets are separated one by one by the separation unit 51 to be sent to the downstream side. The document sheet conveying roller pairs 55 and the like convey the document sheet downstream along the document sheet conveying path 45, and the second reading portion 26 optically reads the image on the back side of the conveyed document sheet. The document sheet is conveyed onto the contact glass 25A by the document sheet conveying roller pairs 55. The laser scanning unit 22 applies light to the front side of the document sheet passing over the contact glass 25A, and the light reflected by the document sheet is input to the reading portion 24 and converted into an electric signal. The document sheet is conveyed further downstream along the document sheet conveying path 45, and the discharge roller pair 54 discharges the document sheet conveyed along the document sheet conveying path 45 from the discharge port 43 toward the discharge tray 34. The discharged document sheet is loaded on the discharge tray 34.

As described above, the images on both the front and back sides of the document sheet are thereby read as image data. The read image data is stored in the memory of the control device 7, and the control device 7 executes the image forming processing (printing) already described. In addition, the image data may be stored in an external terminal without being printed. It is noted that, although the images on both the front and back sides of the document sheet are read in the image reading processing described above, the second reading portion 26 need not be operated if only the image on the front side of the document sheet is to be read. In addition, for example, if the image reading apparatus 1B is designed to read only the image on the front side of the document sheet, the second reading portion 26 may be omitted. That is, the image reading apparatus 1B should have (at least) the reading portion 24 that reads an image of a document sheet conveyed through the document sheet conveying path 45.

By the way, in the document sheet conveying device 21, when a document sheet is conveyed, driving noise (operating noise) generated by the conveying mechanism portion 32 may leak out from the supply port 42 and the discharge port 43. In addition, for example, when a large number of document sheets (bundle of document sheets) are set on the supply tray 33 and the image reading processing is executed, it takes time to complete the image reading processing, so that the user may be temporarily leave the multifunction peripheral 1. Therefore, a third party can peek at the document sheets, and replace or take away a part of the document sheets. Therefore, the document sheet conveying device 21 according to the present embodiment is provided with a cover mechanism portion 35 that suppresses the leakage of the driving noise, the take way of document sheets, and the like.

[Cover Mechanism Portion]

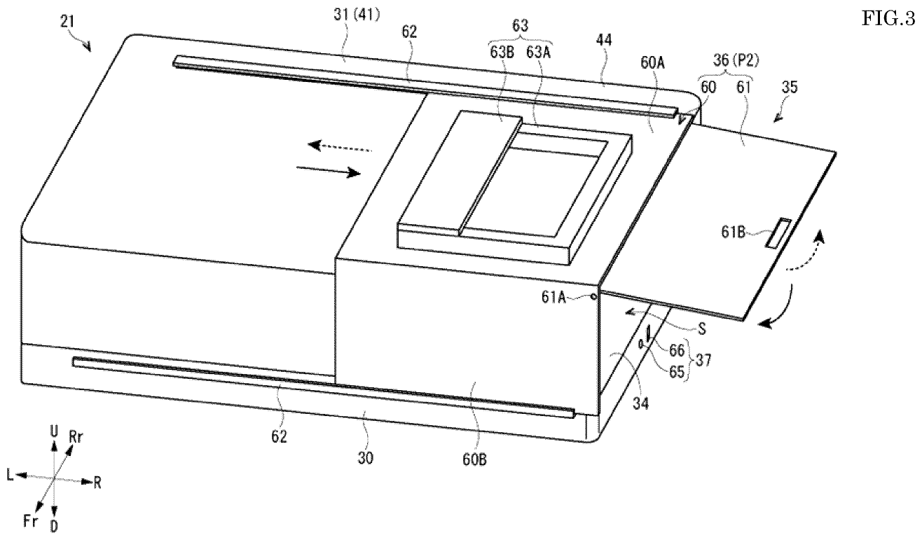

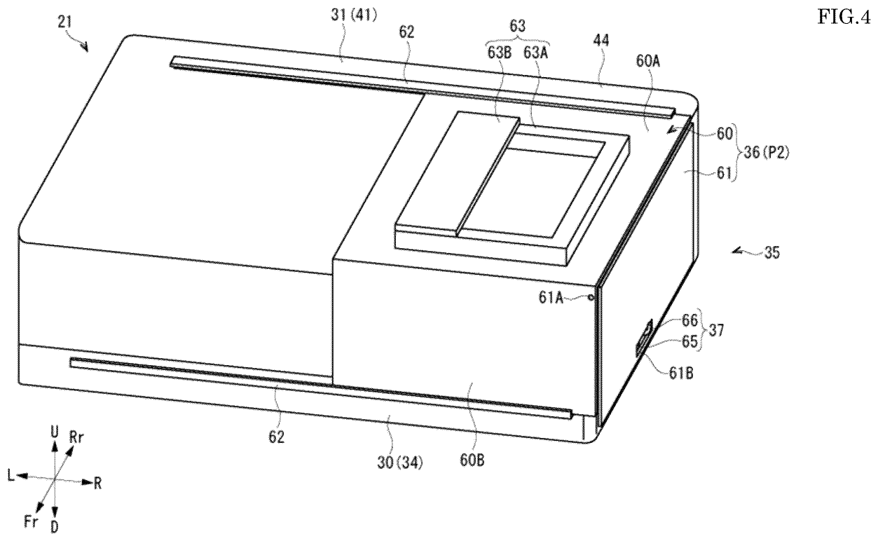

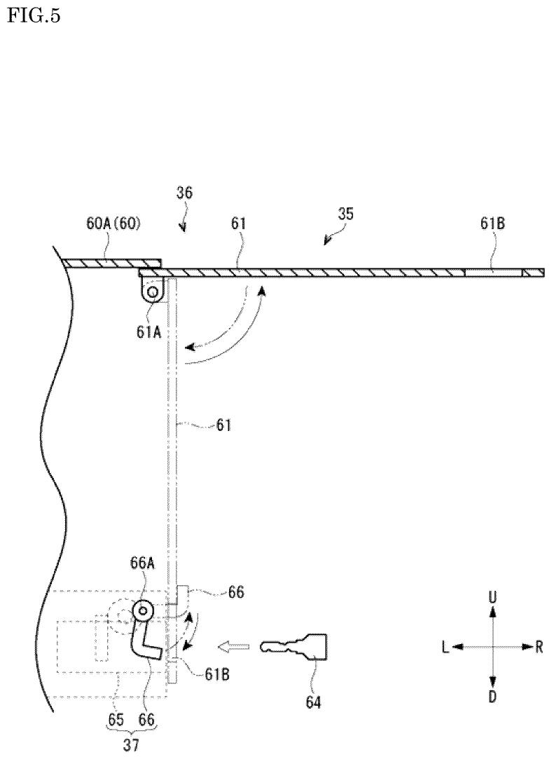

The cover mechanism portion 35 will be described with reference to FIG. 2 to FIG. 5. FIG. 2 is a perspective view (open position P1) showing the document sheet conveying device 21. FIG. 3 is a perspective view (unlocked state) showing the document sheet conveying device 21. FIG. 4 is a perspective view (closing position P2, locked state) showing the document sheet conveying device 21. FIG. 5 is a schematic diagram (front view) showing the cover mechanism portion 35. It is noted that, in FIG. 1 referred to in the above description, the cover mechanism portion 35 is omitted for convenience.

As shown in FIG. 2, the cover mechanism portion 35 includes a slide cover 36 and a lock portion 37.

<Slide Cover>

As shown in FIG. 2 to FIG. 4, the slide cover 36 is formed in a box-like shape that can enclose the supply tray 33 and the discharge tray 34. The slide cover 36 is provided slidably in the left and right directions between an open position P1 for exposing the supply tray 33 and the discharge tray 34 (see FIG. 2) and a closing position P2 for covering the supply tray 33 and the discharge tray 34 (see FIG. 4). When a document sheet is set on the supply tray 33 or taken out from the discharge tray 34, the slide cover 36 is disposed at the open position P1 (see FIG. 2). During execution of the above-described image reading processing, the slide cover 36 is disposed at the closing position P2 (see FIG. 4).

The slide cover 36 includes a cover main body 60 and a side cover 61.

(Cover Main Body)

The cover main body 60 is formed in a substantially L-shape as viewed from the side by connecting a top plate 60A and a front plate 60B. The cover main body 60 is slidably supported by the conveyance housing 31 (housing cover 41). The cover main body 60 reciprocates in the left and right directions along a pair of rails 62 provided on the conveyance housing 31. The pair of rails 62 extend in the left-right direction and arranged parallel to each other. One of the rails 62 is provided from a rear portion of the upper surface of the housing cover 41 to the upper surface of the extension portion 44, and the other one of the rails 62 is provided on the front surface of the document sheet holding portion 30. Each rail 62 has a substantially L-shaped cross section, and a rear end portion of the top plate 60A and a lower end portion of the front plate 60B are slidably fitted into the pair of rails 62.

When disposed at the open position P1, the top plate 60A overlaps the upper surface of the housing cover 41 (the conveyance housing 31) (see FIG. 2), and when disposed at the closing position P2, the top plate 60A covers (the upper side of) the supply tray 33 (see FIG. 3 and FIG. 4). When disposed at the open position P1, the front plate 60B overlaps the front surface of the conveyance housing 31 (the document sheet holding portion 30) (see FIG. 2), and when disposed at the closing position P2, the front plate 60B covers the front side of the discharge space S (the front surfaces of the supply tray 33 and the discharge tray 34 (the front surface of the document sheet holding portion 30)) (see FIG. 3 and FIG. 4).

The top plate 60A is provided with a mounting portion 63 for placing a document sheet. The mounting portion 63 has a wall portion 63A protruding from the upper surface of the top plate 60A and formed in a rectangular annular shape, and a plate portion 63B bridged on the left side of the upper end of the wall portion 63A. The document sheet is inserted below the plate portion 63B and housed in the area surrounded by the wall portion 63A.

(Side Cover)

The side cover 61 is formed in a substantially flat plate shape, and is rotatably connected to the top surface side of the cover main body 60. Specifically, the side cover 61 is supported by a rear right portion of the top plate 60A and an upper right portion of the front plate 60B via an opening/closing shaft 61A. When disposed at the closing position P2, the side cover 61 is placed in a posture (standing posture) hanging from a right end portion (opening/closing shaft 61A) of the top plate 60A, and covers the right side (one of the left and right sides) of the discharge space S (see FIG. 4). When disposed at the open position P1, the side cover 61 is placed in a posture (lying posture) extending to the right (laterally) from the right end portion (the opening/closing shaft 61A) of the top plate 60A, and covers a substantially left half (the pair of cursors 33A) of the supply tray 33 (see FIG. 2). The side cover 61 is supported in contact with the upper end surfaces of the pair of cursors 33A.

<Lock Portion>

As shown in FIG. 2 to FIG. 4, the lock portion 37 is provided at the right end of the discharge tray 34 (document sheet holding portion 30), engages with the side cover 61, and holds the slide cover 36 at the closing position P2.

Specifically, as shown in FIG. 5, the lock portion 37 includes a cylinder 65 that becomes rotatable by inserting a cylinder key 64, and a dead bolt 66 that rotates in conjunction with the cylinder 65. An opening portion 61B is formed in a lower portion of the side cover 61 to expose the cylinder 65 when the slide cover 36 is disposed at the closing position P2 (see also FIG. 2 to FIG. 4). The dead bolt 66 has a substantially L-shaped bent shape, and is supported rotatably around a lock shaft 66A. The dead bolt 66 moves between a position at which the dead bolt 66 protrudes from the document sheet holding portion 30 and is inserted into the opening portion 61B and a position at which the dead bolt 66 is housed in the document sheet holding portion 30 and is disengaged from the opening portion 61B. It is noted that the cylinder key 64 is provided at a predetermined position on the multifunction peripheral 1.

[How to Use Cover Mechanism Portion]

Next, an example of how to use the cover mechanism portion 35 will be described with reference to FIG. 2 to FIG. 5.

<Sliding from Open Position to Closing Position>

The user sets a document sheet on the supply tray 33 with the slide cover 36 disposed at the open position P1 (see FIG. 2), and then slides the slide cover 36 to the right (to the closing position P2) (see FIG. 3). The side cover 61 slides to the right in the lying posture together with the cover main body 60, and when the cover main body 60 moves to a position where the cover main body 60 covers the supply tray 33 and the like, the side cover 61 is rotated downward around the opening/closing shaft 61A by its own weight (see the solid line arrow in FIG. 3 and the dash-dot-dot-dash lines in FIG. 5). As shown in FIG. 4, when the slide cover 36 is disposed at the closing position P2 and the side cover 61 is placed in the hanging posture, the cylinder 65 of the lock portion 37 is exposed from the opening portion 61B of the side cover 61.

The user inserts the cylinder key 64 into the cylinder 65 and rotates it in a locking direction (see FIG. 5). Then, the dead bolt 66 rotates outward, passes through the opening portion 61B, and is engaged with the upper edge of the opening portion 61B (see FIG. 4 and the dash-dot-dot-dash lines in FIG. 5). In this state, the side cover 61 is locked unopenably, and the movement of the slide cover 36 from the closing position P2 to the open position P1 is restricted.

Thereafter, as already described above, the user operates the display input portion to execute the image reading processing. It is noted that the user continues to have the cylinder key 64 until the image reading processing is completed.

<Sliding from Closing Position to Open Position>

After the image reading processing is completed, the user inserts the cylinder key 64 into the cylinder 65 and rotates the cylinder key 64 in an unlocking direction (in a direction opposite to the locking direction) (see FIG. 5). Then, the dead bolt 66 is disengaged from the opening portion 61B (see the solid line in FIG. 5). In this state, the side cover 61 becomes openable (unlocked), and the slide cover 36 is allowed to move from the closing position P2 to the open position P1.

The user slides the slide cover 36 from the closing position P2 to the open position P1. In the process of being slid from the closing position P2 to the open position P1, the side cover 61 interferes with the supply tray 33 and is pushed up (see the broken line in FIG. 3 and the solid line in FIG. 5). Specifically, as the side cover 61 slides to the left, it abuts against the right end of the supply tray 33, so that the side cover 61 is relatively pushed and rotated upward around the opening/closing shaft 61A. Then, the side cover 61 is placed in the lying posture along the supply tray 33 and slides to the left together with the cover main body 60. After disposing the slide cover 36 at the open position P1 (see FIG. 2), the user takes out the document sheet from the discharge tray 34. It is noted that the user returns the cylinder key 64 to the predetermined position on the multifunction peripheral 1.

In the document sheet conveying device 21 according to the present embodiment described above, the slide cover 36 is formed in a box-like shape that can enclose the supply tray 33 and the discharge tray 34, and is slidably provided between the open position P1 and the closing position P2. According to this configuration, the supply tray 33 and the discharge tray 34 can be easily and quickly covered by sliding the slide cover 36 from the open position P1 to the closing position P2. This suppresses leakage of the driving noise from the document sheet conveying device 21, taking away of the document sheet, and the like. In addition, the slide cover 36 is configured to slide from the closing position P2 to the open position P1 while rotating the side cover 61 upward by bringing the side cover 61 into contact with the supply tray 33. According to this configuration, the slide cover 36 in the closing position P2 can be easily moved to the open position P1 without requiring any special operation from the user.

In addition, according to the document sheet conveying device 21 of the present embodiment, the slide cover 36 is held at the closing position P2 by the lock portion 37, so that taking away of the document sheet can be effectively suppressed.

For example, after a certain document sheet (a bundle of document sheets) is read, another document sheet (another bundle of document sheets) may be desired to be read. In this case, the user slides the slide cover 36 to the open position P1, takes out the previously read document sheet from the discharge tray 34, sets the next document sheet to be read on the supply tray 33, slides the slide cover 36 to the closing position P2, and then executes the image reading processing. At this time, the user cannot stably perform works such as setting the next document sheet on the supply tray 33 and closing the slide cover 36 while holding the previous document sheet in his/her hand. In this regard, according to the document sheet conveying device 21 of the present embodiment, since the mounting portion 63 is provided on the top plate 60A, the previously read document sheet can be temporarily placed on the mounting portion 63, so that the user can stably perform works such as setting a document sheet on the supply tray 33 and closing the slide cover 36.

It is noted that, in the document sheet conveying device 21 according to the present embodiment, the cover main body 60 is formed in a substantially L-shape with the top plate 60A and the front plate 60B, but the present disclosure is not limited to this. For example, the cover main body 60 may have a back plate (not shown) in addition to the top plate 60A and the front plate 60B, and the two plates 60A and 60B and the back plate may be connected to each other to form a substantially U-shape (not shown). In this case, one of the rails 62 may be provided from the rear surface of the document sheet holding portion 30 or the rear surface of the housing cover 41 to the rear surface of the extension portion 44 (not shown).

In addition, in the document sheet conveying device 21 according to the present embodiment, the supply tray 33 and the like are provided in front of the extension portion 44, and the back side of the discharge space S is closed by the extension portion 44, but the present disclosure is not limited to this. The extension portion 44 may be omitted (not shown). In this case, the cover main body 60 of the slide cover 36 may be formed in a substantially U-shape (not shown) so as to cover the front side and the back side of the discharge space S by adding a back plate as described above.

In addition, in the document sheet conveying device 21 according to the present embodiment, the lock portion 37 is provided at the right end of the discharge tray 34 (document sheet holding portion 30), but the present disclosure is not limited to this. For example, the lock portion 37 may be provided at the right end of the supply tray 33 (not shown). In addition, for example, the lock portion 37 may be provided on the front surface of the supply tray 33 or the front surface of the discharge tray 34 (the document sheet holding portion 30) and engaged with the front plate 60B of the cover main body 60 (not shown). In this case, although the side cover 61 can be opened, the document sheet on the discharge tray 34 cannot be easily seen, so that the document sheet can be prevented from being peeped. In addition, since the document sheet on the discharge tray 34 cannot be easily taken out, it can be expected to have an effect of suppressing the taking away of the document sheet, and the like.

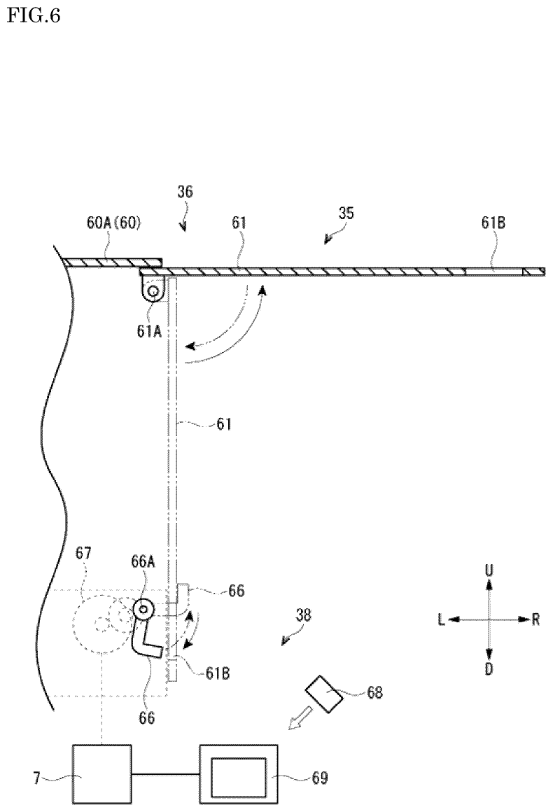

In addition, in the document sheet conveying device 21 according to the present embodiment, the lock portion 37 employs the mechanical cylinder 65 which uses the cylinder key 64, but the present disclosure is not limited to this. For example, as shown in FIG. 6, another lock portion 38 may omit the cylinder 65 (cylinder key 64) and include a drive source 67 such as an electric motor for moving the dead bolt 66, a terminal 68 such as a card or an electronic key incorporating a radio frequency identifier (RFID) tag, an identifier (ID) chip, or the like, and an information reading portion 69 that wirelessly communicates with the terminal (not shown). In this case, identification information of the terminal 68 may be stored in advance in the memory of the control device 7, and the drive source 67 and the information reading portion 69 may be electrically connected to the control device 7 and controlled as appropriate. The user may hold the terminal 68 in his/her possession over the information reading portion 69, and the control device 7 may verify the information read by the information reading portion 69, and if the information matches the stored identification information, the control device 7 may drive the drive source 67 to move the dead bolt 66. For example, when the terminal 68 is held over the information reading portion 69 while the side cover 61 is in the unlocked state, the side cover 61 may be locked, and when the terminal 68 is held over the information reading portion 69 while the side cover 61 is in the locked state, the side cover 61 may be unlocked.

Alternatively, the lock portion may be a padlock (not shown) which is inserted through holes opened in the supply tray 33 and the side cover 61 to lock the side cover 61. Alternatively, the lock portion 37, 38 may be omitted (not shown). When the lock portion 37, 38 is omitted, the slide cover 36 can be freely opened, but a certain effect of preventing the document sheet from being peeped can be expected.

In addition, in the document sheet conveying device 21 according to the present embodiment, the mounting portion 63 is provided on the top plate 60A of the slide cover 36; however, the present disclosure is not limited to this, and the mounting portion 63 may be omitted (not shown).

In addition, the image forming apparatus 1A according to the present embodiment is a monochrome printer, but the image forming apparatus 1A is not limited thereto, and may be a color printer, a copying machine, a facsimile machine, or the like. In addition, although the image forming apparatus 1A employs the electrophotographic method, the image forming method may be an inkjet method.

It is noted that the description of the above-described embodiment shows one aspect in the document sheet conveying device, image reading apparatus, and multifunction peripheral according to the present disclosure, and the technical scope of the present disclosure is not limited to the above-described embodiment. The present disclosure may be changed, substituted, or modified in various ways without departing from the spirit of the technical idea, and the claims include all embodiments that may be included within the scope of the technical idea.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A document sheet conveying device comprising:
a conveyance housing including a document sheet conveying path for conveying a document sheet;
a supply tray which extends from the conveyance housing in one of left and right directions and on which the document sheet is set;
a discharge tray which is provided below the supply tray with a discharge space interposed therebetween, and on which the document sheet fed from the supply tray and conveyed along the document sheet conveying path is loaded; and
a slide cover formed in a box-like shape capable of enclosing the supply tray and the discharge tray and provided slidably in the left and right directions between an open position for exposing the supply tray and the discharge tray and a closing position for covering the supply tray and the discharge tray, wherein
the slide cover includes:
an L-shaped cover main body formed by connecting at least a top plate covering the supply tray and a front plate covering a front side of the discharge space when the slide cover is disposed at the closing position; and
a side cover which is rotatably connected to a top surface side of the cover main body, covers one of right and left sides of the discharge space when the side cover is disposed at the closing position, and is pushed up by interfering with the supply tray in a process of being slid from the closing position to the open position.

2. The document sheet conveying device according to claim 1, wherein
when the slide cover is disposed at the open position, the top surface of the cover main body covers an upper surface of the conveyance housing, and the front plate of the cover main body covers a front side surface of the conveyance housing.

3. The document sheet conveying device according to claim 1, comprising:
a document sheet holding portion which supports a bottom surface of the conveyance housing and extends from a lower side of the conveyance housing in one of the left and right directions to form the discharge tray;
an extension portion which extends in one of the left and right directions from a back side end portion of the conveyance housing and supports a back side end portion of the supply tray;
a first rail which extends in the right and left directions on a front surface of the document sheet holding portion; and
a second rail which extends in the left and right directions on upper surfaces of the conveyance housing and the extension portion, wherein
the slide cover is guided to move in the left and right directions by the first rail and the second rail with the front plate of the slide cover engaging with the first rail and the top plate engaging with the second rail.

4. The document sheet conveying device according to claim 1, wherein the supply tray or the discharge tray is provided with a lock portion that engages with an opening portion provided in the side cover and holds the slide cover at the closing position.

5. The document sheet conveying device according to claim 1, wherein the top plate is provided with a mounting portion for placing the document sheet.

6. An image reading apparatus comprising:
the document sheet conveying device according to claim 1; and
a reading portion configured to read an image of the document sheet conveyed along the document sheet conveying path.

7. A multifunction peripheral comprising:
the image reading apparatus according to claim 6; and
an image forming apparatus configured to form the image read by the image reading apparatus on a medium.
